(19) United States
(12) Patent Application Publication
(10) Pub. No.: US 2014/0272818 A1
(43) Pub. Date: Sep. 18, 2014

(54) Method and apparatus for teaching Spanish

(71) Applicant: Sonia I. Carrasquillo-García, San Juan, PR (US)

(72) Inventor: Sonia I. Carrasquillo-García, San Juan, PR (US)

(21) Appl. No.: 14/216,277

(22) Filed: Mar. 17, 2014

Related U.S. Application Data
(60) Provisional application No. 61/800,086, filed on Mar. 15, 2013.

(51) Int. Cl. G09B 19/06; A63F 3/04

(52) U.S. Cl. CPC G09B 19/06; A63F 3/0402
USPC 434/129

(57) ABSTRACT

A method and system comprising an educational game board for teaching children and adults the following Spanish language skills features (vocabulary, phonetics, reading skills and orthography) in an entertaining way. The educational game consists of a game board with multiple word cards with printed words, at least two types of markers, each marker representing a pronunciation rule and made of any appropriate material. The game board has a grid with three rows and three columns, with full color pictures and words printed on it. The markers are used by the students to, and. The student or player will have to listen to the word read from the card picked up by the teacher, identify said word in the game board, decide between the markers which marker represent the pronunciation rule of said word and cover the called word with the selected marker. The teacher may supervise the performance of each student while they discriminate between the selected pronunciation rules. The first player that covers each space of the grid for the game board correctly wins. The same process is repeated for the remaining students to allow the teacher assess their language skills.

### RELATED APPLICATIONS

This application claims the benefit of U.S. Provisional Application No. 61/800,086 filed Mar. 15, 2013, which is hereby incorporated by reference in its entirety.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISK APPENDIX

N/A

### TECHNICAL FIELD

The present invention relates to a method and a manipulative game to be used mainly in a classroom for teaching Spanish language skills, particularly, pronunciation rules. Specifically, the present invention relates to a method for teaching the language properties or features of a diphthong and a hiatus, to help the student acquire reading skills, writing skills, learn orthography and vocabulary words in Spanish, and to improve his or her spelling in Spanish through the use of a game played by students and their teacher, by means of a game board with full color pictures, printed words on it, two types of hexagonal tokens, and several word cards, that encourage learning these skills while playing and strengthening their social abilities.

### BACKGROUND OF THE INVENTION

Language is an important skill that allows a person to communicate. Language development is important to a child in order to adequately exchange information with others in a meaningful way so he or she can benefit from education. A delay in language skills can cause frustration for a child as well as miscommunication about what he or she may be trying to convey.

Language development is important to a child in order to adequately exchange information with others in a meaningful way. Some traditional approaches of teaching language skills often discourage students from learning and this may have short-term and long-term effects in their social and academic performance. There is vast scientific evidence that demonstrates the benefits of educational games in the learning process and in the development of communication and social skills. The present invention promotes these mentioned skills through the use of a word structure game.

The use of games for teaching aspects of language is a didactic strategy to facilitate learning in an entertaining and amusing way, especially in classrooms. However, there are few games boards of this type created in Spanish that responds to distinctive features inherent of the language. In the vast majority, the Spanish games are translations of English versions and focus on the development of vocabulary.

There are a number of methods that provide a teacher a means to teach her students new vocabulary, orthography and phonetics. However, none of those games is designed to specifically help students within the auditory process of perception, discrimination, and production of hiatuses and diphthongs in Spanish. The following is a list of the prior art more relevant to the petition:

1. Beardsley (U.S. Pat. No. 5,458,338) teaches grammar having a key card formed by multiple rows and columns, including columns with a heading across the top of a column with the letter that indicate the language feature (LINGO). It relates to a game teaching the elements of English grammar through the use of a game board played by multiple people in a bingo like game.
2. Visser et al. (U.S. Pat. No. 5,743,740) a multilevel educational board game to teach children and adults English pronunciation and vocabulary, utilizing phonetics, words, phrases, numbers, symbols and pictures to maintain the attention and interest of the players. It is designed in a bingo board format.
3. McFadden (U.S. Pat. No. 4,082,279) an educational board game to teach young children the rudiments of spelling and reading. It is designed as a game board having a playing surface and a plurality of game areas, each area receives a single game piece bearing selected phonemic indicia,
4. Ratzkoff (U.S. Pat. No. 4,046,382) a word game apparatus that familiarizes the user with vocabulary words, their definitions and spelling. It includes a plurality of playing boards having words from specific topics arranged in rows and columns thereon.
5. Wayne (U.S. Pat. No. 3,464,124) a phonogram teaching device to help children to learn how to read, it consists of a square playing board for each player, with adjoining square spaces with a word in it, and all of the spaces covering the board, a deck of phonogram cards and several sets of markers.
6. Darden (CA Patent 491,948) an educational game played with words particularly adapted for use in classroom. The game includes several boards with columns of words, adapted to receive markers, which are placed over the squares by the student. When a row of words is covered, the student will announce it by calling “word-o”.

All in all, current options available in the market for teaching phonetics are either ineffective or does not promote the phonetic emphasis of a word of a particular language in a fun way. Accordingly, there remains a need for method or system which is effective for learning word pronunciations to overcome the disadvantages and shortcomings of the prior art.

### SUMMARY OF THE INVENTION

The present invention relates to a method and a manipulative game to be used mainly in a classroom for teaching Spanish language skills, particularly, pronunciation rules. The game for language pronunciation comprises a plurality of game boards, wherein each game board comprises a heading and a grid divided into three rows and three columns configured to generate nine individual squared spaces, wherein said nine individual squared spaces comprises at least a first individual space; wherein said at least first individual space comprises a first printed word selected from a first group of words and an image representing said first printed word; a plurality of cards comprising a first card, wherein said first card comprises said first printed word; and at least a first plurality of markers comprising a first mark, wherein said first mark is configured to represent a first particular pronunciation rule.

The pronunciation rule may be selected from a variety of rule depending on the language. For example if Spanish is selected pronunciation rules such as diphthong and hiatus could be selected. In Spanish a vowel is a “voiced speech sound resulting from the unrestricted passage of air stream thought the mouth or nasal cavity without audible friction or stoppage. . . . ” Further, a diphthong is the union of two consecutive vowels sounds, a strong (a-e-o) and weak (i-u), which are pronounced in the same syllable. Also, a diphthong is formed when two weak vowels (i-u) are together in one syllable. The third possibility is a diphthong when a strong vowel with a diacritic accent (a-e-o), binds with weak vowel (iu); when this happens the strength of the strong vowel (a-e-o) increases, but remains attached to the weak vowel sound (iu). The fourth possibility is a diphthong formed by a weak vowel with a weak vowel with a diacritic accent. In this kind of diphthong, a weak vowel becomes strong and stays together. The fifth possibility is when the letter or grapheme “h”, without phonetic representation in Spanish, is between two vowels. The letter “h” between vowels does not prevent the formation of a diphthong. The following words are examples of diphthongs variation: boina-'boj na (weak and a strong vowel); Luisa- 'luj sa (two weak vowels); biólogo- 'bjo lo yo (weak and a strong vowel with a diacritic mark); siéntate- 'sje ta to (weak vowel with the weak vowel with a diacritic mark); and ahumado-aw' ma do (a strong and a weak vowel with an “h” between them).

On the other hand, a Spanish hiatus is the separation of two continuous strong vowels to form different syllables. There may be a hiatus by the combination of a strong vowel with a weak vowel with a diacritic accent or when there is a grapheme “h”, without phonetic representation in Spanish, between to strong vowels, or between a strong vowel and a weak vowel with diacritic accent, forming different syllables. The following are examples of hiatus: caer-[ka 'er]; oído; [o 'i do]; y buho- ['bu o].

In accordance with present disclosure the game comprises thirty (30) game boards, forty-eight (48) tokens and forty-eight (48) word cards. Each student will have a game board with three (3) columns and three (3) rows, with eight (8) pictures, printed words and a blank space in the very center of the board, and the word “Hiptongomanía” as the heading of it. The game board resembles a grid, or a 3 by 3 matrix, with a total of nine (9) squares in it. Each square contains a different colored picture with the name in Spanish below the picture, to facilitate visual cues to the students. Each such name in Spanish represents the object or thing depicted by the picture, except the center of the grid which has no picture in it but contains the phrase “Gratis 100%” (which means “100% Free”). Each full colored picture in the board represents a Spanish word with either a diphthong or a hiatus.

Another object of the present invention is to promote the pronunciation skill of each student. In accordance with the principles of the present invention the teacher distributes the game boards, the red hexagonal token representing a first pronunciation rule, such as the diphthongs, and the blue hexagonal tokens representing a second pronunciation rule such as the hiatus, among players, while she holds the word cards. The teacher draws a card and calls the word on the card. The student has to locate the word on the board and place either a blue or a red token on the called word. If the called word is not on the board, the teacher will draw a new card. But if the called word is on the board, each student has to decide whether or not the word has a diphthong or a hiatus. If the student concludes that the word is a hiatus, he or she needs to select the blue token. On the contrary, if the students conclude that the word is a diphthong, he or she must select a red token. Once the tken is selected is placed on top of the word at the board game. The process repeats until a student fills his or her game board (which contains a total of eight (8) spaces to be filled) with the correct tokens on the board and says aloud “Game” (which means “I won”), which alerts all the other players about a possible win to the game. All of the wins are then checked for accuracy before being officially confirmed by the teacher. The teacher should supervise the student's performance on the game, after calling the word.

### BRIEF DESCRIPTION OF THE DRAWINGS

FIG. 1—shows an exemplary embodiment of the game board in accordance with the principles of the present disclosure.

FIG. 2—shows an exemplary embodiment of the first marker in accordance with the principles of the present disclosure.

FIG. 3—shows an exemplary embodiment of the second marker in accordance with the principles of the present disclosure.

FIG. 4—shows an exemplary embodiment of the card in accordance with the principles of the present disclosure.

### DETAILED DESCRIPTION OF THE INVENTION

FIG. 1 is directed to exemplary embodiment of the game board, which consists of a board 1 of any appropriate material, with a header 2, a grid 3 comprising at least three columns and at least three lines, wherein said grid 3 also comprises a picture 4 and a word 5 on each space 31. The word 5 represents or is correlated to the design of the picture 4. Each word 5 printed on the board 1 comprises a particular pronunciation, for example the word could be either a hiatus or a diphthong.

FIG. 2 is directed to an exemplary first marker 6 or token from a plurality of a first plurality of markers to be used by the students to designate/cover a called word 9 that is affected by a particular first pronunciation rule. For example the first marker may be configured to have a hexagonal shape, made of any appropriate material such as plastic or wood. Further, said first plurality of markers may be designates to represent a first pronunciation rule in a first language such as Spanish. The first marker is configured to provide a distinctive design, shape and/or indicia 61 from any other plurality of markers used with the game.

FIG. 3 is directed to an exemplary second marker 7 or token from a plurality of a second plurality of markers to be used by the students to designate/cover the called word 9 that is affected by a particular first pronunciation rule. For example, the second marker 7 may be configured to have a hexagonal shape, made of any appropriate material such as plastic or wood. Further, said first plurality of markers may be designates to represent a second pronunciation rule for said first language, such as Spanish. The second marker 7 is configured to provide a distinctive design, shape and/or indicia 62 from any other plurality of markers used with the game.

FIG. 4 is directed to the plurality of cards, each card 8 including at least a called word 9. The called word 9 is affected either by a first said pronunciation rule or a second said pronunciation rule.

The present invention, as mentioned before, is a method and a manipulative game apparatus to be played for teaching language skills, such as Spanish, particularly adapted to use in the classroom. In the exemplary embodiment comprises thirty game boards 1, one hundred twenty of said first plurality of markers 6, one hundred twenty of said second plurality of markers 7 and forty-eight of said first group of words 8. Each student will have a game board 1 which contains a grid 3 with three columns and three rows, resembling a 3 by 3 matrix with nine (9) spaces 31 in it. Each grid 3 has nine (9) spaces 31 with one picture 4 in each space 31, a printed word 5 below each such picture 4 and a blank space 315 in the very center of the board 1, and a heading space 2 with the word “Hiptongomanía” 21 as the heading of it. Each space 31 contains a different color picture 4 with the word 5 in Spanish below the picture 4 that represents the name of that picture 4, to facilitate visual cues to the students. Each such word 5 in Spanish represents the object or thing depicted by the picture 4. The center of the grid 3 is a blank space 315 that has no picture in it but contains the phrase “Gratis 100%” (which means “100% Free”). Each full color picture 4 in the board 1 represents a Spanish word 5 which is either a diphthong or a hiatus.

In order to play the game the teacher distributes the game boards 1, the said first plurality of markers 6 representing a first particular said pronunciation rule, and the said second plurality of markers 7 representing a second particular said pronunciation rule, among players, while she holds the word cards 8. The teacher draws a card 8 and calls the word 9 on the card 8. The student has to locate the same word 5 on the board 1 and place either one maker from said first plurality of markers 6 or from said second plurality of markers 7 on the called word 9. If the called word 9 is not on the board 1, the teacher will draw a new card 8. But if the called word 9 is on the board 1, each student has to decide whether or not the word 9 is affected by said first pronunciation rule or by said second pronunciation rule. If the student concludes that the word 9 is affected by a first said pronunciation rule, he or she needs to select a marker from said first plurality of markers 6. On the contrary, if the students conclude that the word 9 is affected by a second pronunciation rule, he or she must select a marker from said second plurality of markers 7. The process repeats until a student fills his or her game board 1 (which contains a total of eight (8) spaces to be filled) with the correct markers on the board 1. Once the board is completed the student should alert the teacher and all the other players. All of the completed boards are then checked for accuracy before being officially confirmed as a winner by the teacher. After the teacher confirms that the student correctly filled the game board 1 the process repeats for the remaining students to allow them to fill their respective boards 1. The teacher should supervise the student's performance on the game after calling each word 9 to assess the mastery of the skills.

What is claimed is:

1. A game for language pronunciation comprising:
a plurality of game boards, wherein each game board comprises a heading and a grid divided into three rows and three columns configured to generate nine individual squared spaces, wherein said nine individual squared spaces comprises at least a first individual space;
wherein said at least first individual space comprises a first printed word selected from a first group of words and an image representing said first printed word;
a plurality of cards comprising a first card, wherein said first card comprises said first printed word; and
at least a first plurality of markers comprising a first mark , wherein said first mark is configured to represent a first particular pronunciation rule.

2. The game for language pronunciation as in claim 1, wherein said first group of include words governed by said first particular pronunciation rule.

3. The game for language pronunciation as in claim 1, wherein said nine individual squared spaces comprises at least a second individual space, wherein said at least second individual space comprises a second printed word selected from a second group of words and an image representing said second printed word.

4. The game for language pronunciation as in claim 3 comprising at least a second plurality of markers comprising a second mark, wherein said second mark is configured to represent a second particular pronunciation rule.

5. The game for language pronunciation as in claim 4, wherein said first group of include words governed by said first particular pronunciation rule; and wherein said second group of include words govern by said second particular pronunciation rule.

6. The game for language pronunciation as in claim 1 wherein said grid comprises a middle space, wherein said middle space is open space.

7. The game for language pronunciation as in claim 1 comprising an instruction manual for players.

8. A method for teaching pronunciation rules, comprising the steps of:
a) providing a plurality of game boards, wherein each game board comprises a heading and a grid divided into a plurality of individual spaces, wherein each individual space comprises a particular printed word, wherein said particular printed word is selected from a group of a proper pronunciation rule, wherein said particular printed word on each individual space is different,
b) providing a game board to at least a student,
c) a teacher drawing a card from a plurality of cards, wherein said card comprises a second printed word;
d) said teacher calling said second printed word out loud;
e) the student listening to the second printed word;
f) locating said second printed word on the game board;
g) the student determining at least a particular pronunciation rule for said second printed word,
h) selecting a marker from a plurality of markers, wherein said marker is configured to represent said particular pronunciation rule,
i) placing the marker on the particular printed word matching said second printed word,
j) the teacher supervising the student to ensure the marker placed on said printed word is correlated to said proper pronunciation rule; and
k) repeating the steps c) to i) until said student fills all the spaces in the grid with markers.

9. The method for teaching pronunciation rules as in claim 8, wherein said grid comprises three rows and three columns configured to generate nine individual squared spaces.
